(19) United States
(12) Patent Application Publication
(10) Pub. No.: US 2020/0352828 A1
(43) Pub. Date: Nov. 12, 2020

(54) Apparatus Useful for Infant Teething and Suckling

(71) Applicants: Phillip Romig, Lake Charles, LA (US); Heather Romig, Lake Charles, LA (US)

(72) Inventors: Phillip Romig, Lake Charles, LA (US); Heather Romig, Lake Charles, LA (US)

(21) Appl. No.: 16/409,812

(22) Filed: May 11, 2019

(51) Int. Cl. A61J 17/00; A61J 17/02

(52) U.S. Cl. CPC A61J 17/007; A61J 17/02

(57) ABSTRACT

The present invention teaches an apparatus that is simultaneously useful for both teething and suckling. The apparatus includes an article of manufacture including a teething section and a section that simulates a nipple for suckling. The invention takes into account the natural position of the infant's thumb during suckling. In addition, the invention teaches regulating the amount of saliva resting on the teething and sucking apparatus surface. Further still, the invention teaches using an elongated strap to secure the teething and sucking apparatus to the infant's wrist to prevent losing it.

### FIELD OF INVENTION

This invention relates to an apparatus for easing irritation resulting from teething and providing the comfort of nursing for an infant.

### BACKGROUND OF INVENTION

Being an infant can be a very difficult assignment. It is well known that teething relieves the irritation that infants experience when their teeth are making their way through the infant's gumline. It is also well known that nursing (i.e., suckling) will comfort the infant when the infant is feeling unease.

There have been several prior attempts to alleviate the irritation of the infant gums. For example, traditional pacifiers such as those disclosed in U.S. Pat. No. 10,195,118, (the “'118 patent”), titled “Pacifier”, issued Feb. 5, 2019, to Eerden, may be inserted into the infant's mouth. When inserted into the mouth, the infant may repeatedly clamp the infant's gums onto the pacifier, thereby relieving the irritation. Unfortunately, pacifiers, such as described in the '118 patent suffer from the problem that they are easily misplaced when separated from the infant or the parent.

U.S. Pat. No. 6,634,919, (the “'919 patent”) issued Oct. 21, 2003 to Gordon, et al., is another attempt to provide a pacifier for an infant to use during teething. The '919 patent teaches placing a pacifier in a child's toy, wherein the toy is shaped like an animal and the pacifier serves as the animal's nose. Although, placing the pacifier in a toy may increase the chances the pacifier won't get lost because the infant, or parent is more likely to remember a toy than a pacifier, the toy-pacifier suffers from the problem that it still may be lost because of the infant's lack of manual endurance. That is, after only a short period of time, the infant's hand will relax. Consequently, the invention of the '919 patent is prone to be lost, in similar manner as was described with the '118 patent above.

There have been several attempts to solve the problem of losing pacifiers. For example, U.S. Pat. No. 2,586,608, (the “'608 patent”) issued Feb. 19, 1952 to Bryson, teaches a “Teething Mitten for Babies.” However, the '608 patent is complicated in design as it teaches a covering for an infant hand that includes a sheath having an outer pocket in which a filler is inserted to provide a predetermined shape to the sheath. The '608 patent is inconvenient in that the filler must be inserted prior to use.

U.S. Pat. No. 5,385,573, (the “'573 patent”) issued Jan. 13, 1995 to Wright, is another attempt to solve the problem of losing pacifiers. Accordingly, the '573 patent teaches a mitten for an infant's hand, wherein the mitten includes the upper torso of a puppet. The upper torso of the puppet serves as an infant teether. The teether includes a handle end located inside the mitten to be used for the infant to grab and hold during teething. The '573 patent attempts to solve the problem of losing pacifiers by including a wrap around the lower mitten that secures the mitten to the infant wrist. However, the '573 patent suffers from the problem that it relies on the dexterity of the infant's hand to maintain the puppet in an upright position for teething. It is well known, that an infant's hand lacks the dexterity and endurance owed to an adult hand. That is, as noted above, the infant's hand will release after a period. When the infant release the handle, the puppet will fall to the side, which makes it inconvenient to use as a teether.

U.S. Patent Application No. 2005/0222621 A1 (the “'621 application”) to Duwellius, et al, now abandoned, teaches yet another method of providing a teether that attempts to solve the problem of losing pacifiers. The '621 application teaches an article of manufacture for biting by teething infants. The '621 application teaches a teething device constructed to affix to a mitten. The mitten is constructed to fit over the infant's hand. The mitten is then secured to the infant's hand using, for example, a strap, such as a hook and loop strap, like Velcro®.

The '621 application solves the problem of losing the pacifier because the hook and loop strap secures the mitten to the infant's hand. The hook and loop strap ensures that the mitten stays in place on the infant's hand, with little movement about the hand. Moreover, because the mitten stays in place with little movement, the teething device stays in place for easy access by the infant.

However, the '621 application is deficient in that it merely addresses teething. The '621 Application does not address the nursing problem. That is, the apparatus taught in the '621 application is not useful for comforting an infant needing to nurse or suckle. Additionally, the apparatus does not accommodate the natural location of the infant's thumb taken when the infant sucks his thumb. That is, the mitten disclosed in the '621 application forces the infant to keep the infant's hand in a cramped first position during teething. In general, when not nursing, the infant may suckle his thumb for comfort. A suitable apparatus would take into account the natural position of the infant's the thumb, such as when the infant sucks its thumb. Further still, while the '621 application addresses the issue of losing the teether as discussed above, the application does not provide a means for comforting an infant needing to suckle for comfort. In fact, the '621 application is emblematic of prior art having a teething and mitten combination. That is, these prior arts do not teach a means for the child to nurse. Moreover, the aforementioned patents, applications and similar prior art inventions do not suggest an apparatus having a teether and pacifier means in combination.

One prior art that teaches a teether and pacifier combination is taught by U.S. Patent Application No. 20070288056 (the “'056 application”) to Goldwire, now abandoned. The '056 application improves on the teachings of the '621 Application in that it teaches a mitten that combines a teether and pacifier. The '056 application teaches that a mitten is worn on the hand to facilitate the teething process. The '056 application additionally teaches the mitten includes a compartment on either side of the central axis of the mitten in which the thumb may be inserted. The mitten is secured to the hand using Velcro®, ties, straps, or elastic. In various embodiments of the '056 application, the teether may be placed on either side or the top of the mitten. To facilitate a pacifier, the user may turn the mitten inside out using the opposite side of the teether as a pacifier.

While the '056 application addresses many problems associated with the prior art, the teachings of the '056 application are deficient in that the they do not provide a teether and pacifier combination that takes into account the natural placement of the infant's thumb, such as during suckling (i.e., sucking his thumb). According to the '056 application, it teaches that a compartment may be used to accommodate the thumb. However, the compartment is on either side of the central axis of the mitten. The '056 application does not provide a mitten that takes into account the infants thumb. That is, the invention of the '056 application is not ergonomically sound in that the compartment is an open compartment on either side, which may accommodate the thumb. The '056 application does not teach or suggest the existence of a portion of the mitten specifically designed for fitting the infant's thumb. What is needed in a teething and pacifying apparatus including a portion that offers increased stability of the teething or pacifying apparatus, using for example, the thumb. Such an apparatus may include using the thumb as a stabilizing anchor in that the thumb would stabilize movement of the mitten. Such needed apparatus may be ergonomically designed to accommodate the infant's thumb.

The '056 application is further deficient in that the device must be removed from the infant's hand, and the device turned around or inside-out, to access the pacifier option of the invention. The invention of the '056 application is inconvenient in that it requires an adult's intervention to switch between teething and suckling. This requires effort and time during which the infant is experiencing discomfort. What is needed is a teething and suckling apparatus that does not require user intervention, and that will allow the infant to seamlessly switch between teething and suckling.

In addition to the above deficiencies, the prior art teething devices using a mitten are also deficient in that they do not allow for the infant's saliva to be drawn away from the teething portions of the mitten. Such a teething or suckling device would allow room for new deposits of saliva, thereby ensuring that the teething or suckling device does not become unduly moist.

What is needed is a device that combines the irritation relieving properties of a teether, with the comforting properties of a pacifier, but that also accommodates the natural position of an infant's thumb during suckling, relieves the moister build-up of the teething and suckling apparatus, and that solves the problem of losing the device.

### SUMMARY OF THE INVENTION

The present invention teaches improvements not found in the prior art. It is an object of the invention to provide a device that is suitable for both comforting an infant during suckling and relieving an infant's irritation during teething. In one aspect, the present invention teaches a device that combines a teether and a sucking portion in one apparatus for use by an infant. The present invention teaches a more convenient teething and suckling apparatus, in that the apparatus taught herein includes a teething portion and a suckling portion which are simultaneously accessible by the infant.

It is also an object of the present invention to provide a teething and suckling apparatus that is ergonomic in that it takes into account the natural position of an infant's thumb during suckling. It is well known, that an infant will suck its thumb to comfort itself when it is not nursing. The present invention teaches a teething and suckling device that takes advantage of this position to provide further comfort to the infant during suckling.

It is further an object of the present invention to provide a teething and sucking apparatus that is secured against misplacing it. As such, in one aspect, the invention, teaches a teething and sucking apparatus that is secured to the infant's wrist to prevent losing it. In this way, the invention teaches means to ensure the apparatus so that the apparatus remains with the infant until removed by an adult.

It is still another object of the invention to provide a teething and suckling apparatus that regulates the amount of moister able to be contained on the teething and suckling apparatus. In yet another aspect, the invention teaches a teething and suckling apparatus containing a channel for releasing excess moister deposited on the outer surface of the teething and suckling apparatus.

### BRIEF DESCRIPTION OF DRAWINGS

A more complete understanding of the present invention may be derived by referring to the various embodiments of the invention described in the detailed descriptions and drawings and figures in which like numerals denote like elements, and in which:

FIG. 1 shows an exemplary teething and suckling apparatus according to the present invention;

FIG. 2 shows an opposite side view of an exemplary embodiment of a teething and suckling apparatus, in accordance with various embodiments of the present invention;

FIG. 3 depicts a perspective view of an exemplary embodiment of a teething and suckling apparatus, in accordance with various embodiments of the present invention;

FIG. 4 depicts a frontal view of an exemplary embodiment of a teething and suckling apparatus, in accordance with various embodiments of the present invention;

FIG. 5 depicts a rear facing view of an exemplary embodiment of a teething and suckling apparatus, in accordance with various embodiments of the present invention;

FIG. 6 depicts a teething and suckling article of manufacture useful with the present invention;

FIG. 7 depicts a perspective view of the teething and suckling apparatus, in accordance with the present invention;

FIG. 8 depicts and exemplary fabric enclosure useful with the present invention;

FIG. 9 depicts a bottom perspective view of an exemplary fabric enclosures, in accordance with various embodiments of the invention;

FIG. 10 depicts another exemplary embodiment of a teething and suckling apparatus according to the present invention illustrating a method for affixing a fabric mitten to a teething and suckling device, according to the present invention;

FIG. 11 depicts still another exemplar embodiment of a teething and suckling apparatus according to the present invention illustrating another exemplary affixing means for the fabric enclosure;

FIG. 12 depicts still another exemplar embodiment of a teething and suckling apparatus according to the present invention illustrating another exemplary affixing means for the fabric enclosure;

FIG. 13 depicts an exemplar embodiment of the elongated strap for use with the invention;

FIG. 14 depicts an exemplary elongated strap affixed to the teething and suckling apparatus in accordance various embodiments of the present invention, wherein the elongated strap is in an open position;

FIG. 15 depicts an exemplary elongated strap affixed to the teething and suckling apparatus in accordance various embodiments of the present invention, wherein the elongated strap is in a closed position;

FIG. 16 depicts an exemplary material projection and channel for directing the flow of saliva, in accordance with the present invention; and

FIG. 17 depicts another exemplary material projection and channel for directing the flow of saliva, in accordance with the present invention, wherein the material projection is in sections.

### DETAILED DESCRIPTION

The brief description of exemplary embodiments of the invention herein refers to the accompanying drawings, which show the exemplary embodiments by way of illustration and its best mode. While these exemplary embodiments are described in enough detail to enable those skilled in the art to practice the invention, it should be understood that other embodiments may be realized, and that logical and mechanical changes may be made without departing from the spirit and scope of the invention. In addition, for the sake of brevity, conventional techniques of determining dimensional sizes of human body-parts, such as used when making prosthesis, will not be described herein in detail. Thus, the description herein is presented for purposes of illustration only and not of limitation.

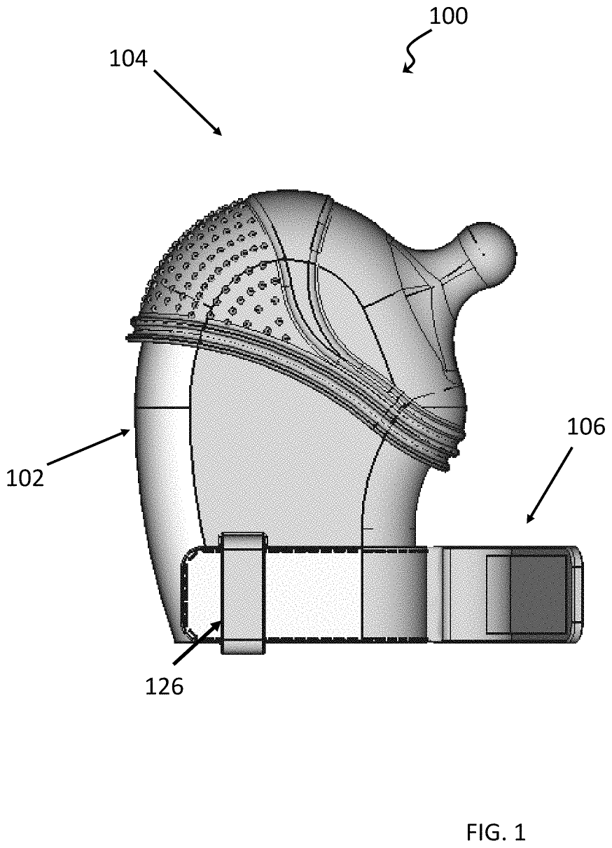

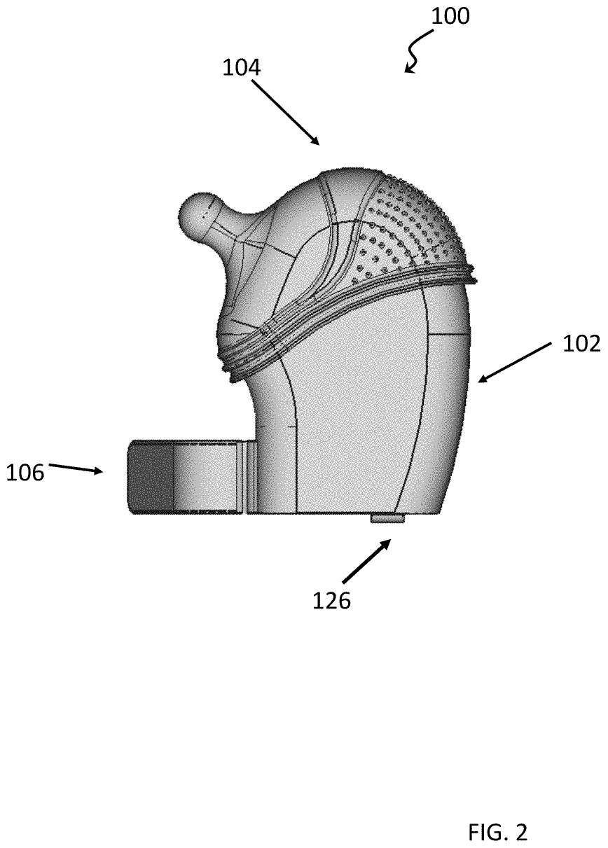

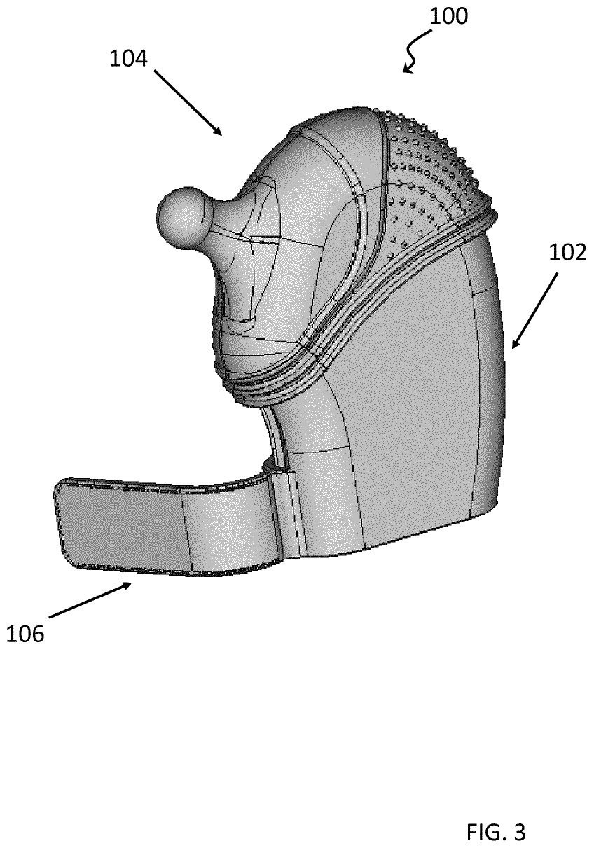

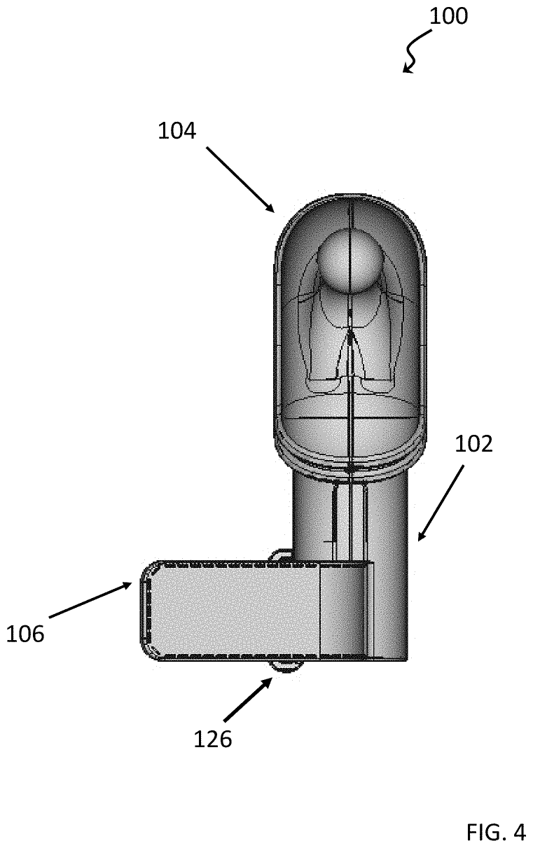

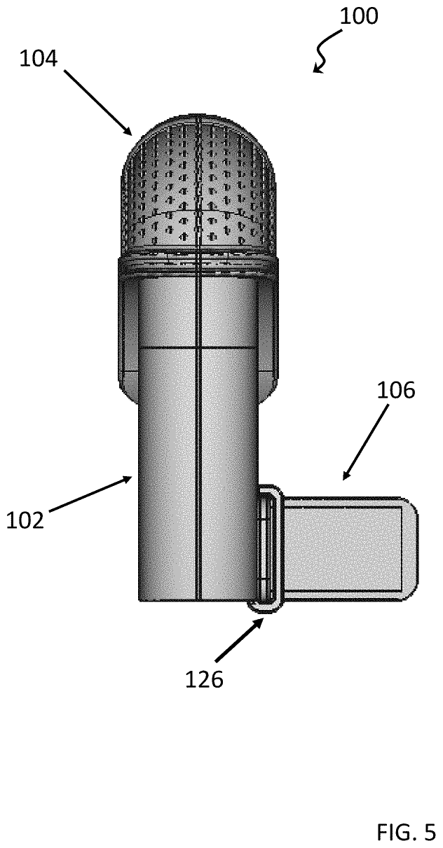

With reference to FIG. 1-5, what is shown is a teething and suckling apparatus 100 for use in relieving an infant's irritation caused by teething, and for providing comfort during suckling. FIG. 1 depicts teething and suckling apparatus 100 from a right facing view; FIG. 2 depicts teething and suckling apparatus 100 from a left facing view; FIG. 3 depicts teething and suckling apparatus 100 is perspective view; FIG. 4 depicts teething and suckling apparatus 100 in front facing view; and FIG. 5 depicts teething and suckling apparatus 100 from rear facing view.

Teething and suckling apparatus 100 may include a fabric mitten 102. Teething and sucking device 104 may be affixed to a first end of fabric mitten 102. An elongated strap 126 is affixed to the fabric mitten 102 in proximity to a second end of fabric mitten 102. As described more fully below, elongated strap 126 is useful for cinching the second end of fabric mitten 102 around an infant's wrists. The cinched elongated strap 126 may be held securely around the infant's wrist using a fastener, such as, a clasp, button, hook and loop material, or other similar conventional fastener.

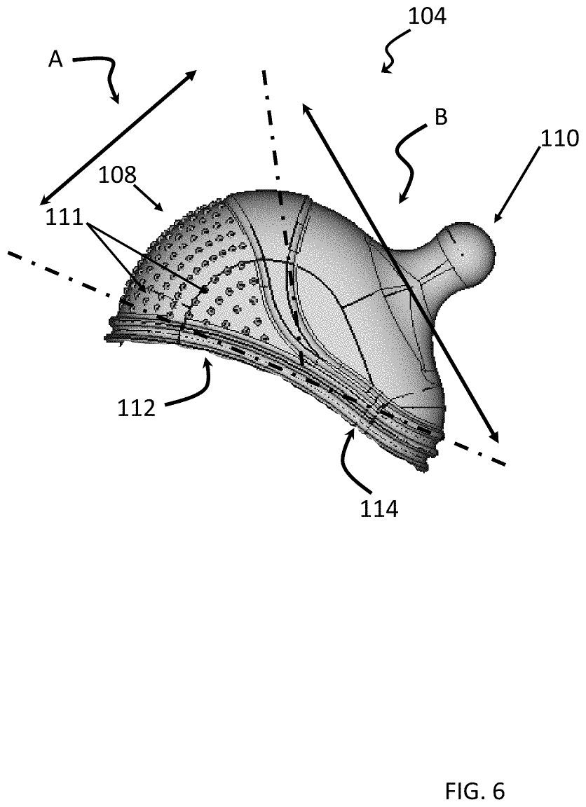

FIG. 6 depicts and exemplary teething and suckling device 104 that may be used with the present invention. Teething and suckling device 100 may be an article of manufacture. Teething and suckling device 104 may be constructed of material safe to include in an infant's mouth, such as, food grade silicon. In some preferred embodiments, teething and suckling device 104 may be hemispheric in shape.

In one exemplary embodiment, teething and suckling device 104 may include a teething section 108. Teething section 108 may be located in proximity to a first section, A, of teething device 104. In one exemplary embodiment, first section A is located on one half of teething and suckling apparatus 100. Teething section 108 may included raised material, such as bumps 111. During use, an infant may use teething bumps 111, which the infant may use to relieve irritation of the gums.

In one exemplary embodiment, teething and suckling device 104 may include a suckling section 110. Suckling section 110 may be located in proximity to a second section, B of teething device 104. Section B may be on one half of teething and suckling apparatus 100. Suckling section 110 may include material configured to be shaped like a nipple. In one exemplary embodiment, suckling section 110 may be shaped like a human nipple. During use, an infant may use the nipple of section 111 to comfort himself. For example, the infant may suckle on the nipple until he is calmed.

Teething section 108 and suckling section 110 may be placed adjacent one to the other. That is, section A of teething and suckling apparatus 104 may be adjacent to section B of teething and suckling apparatus 104. Further still, teething section 108 and suckling section 110 are preferably on the outer surface of teething and suckling apparatus 104.

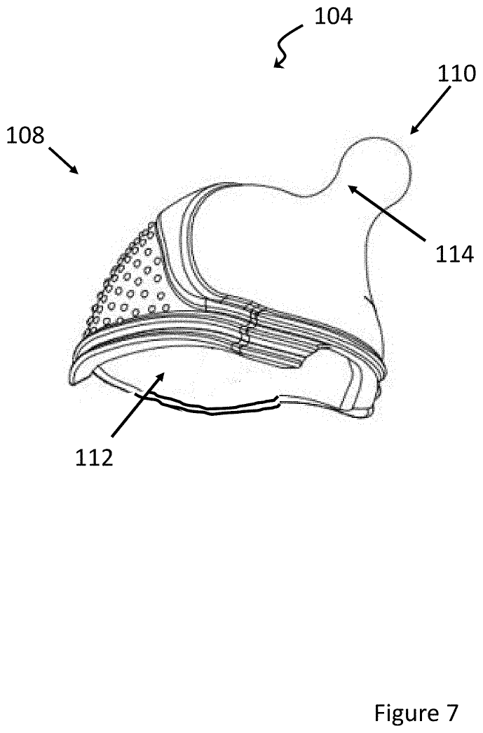

FIG. 7 depicts a perspective view of teething and suckling apparatus 104 may be configured to receive fabric mitten 102. That is, teething and suckling apparatus 104 may be concave under teething section 108. Teething and suckling apparatus 104 may further be concave underneath sucking section 110. More particularly, teething and suckling apparatus 104 has a first teething section cavity 112 under teething section 108, and a suckling section 110 includes a suckling section cavity 114 under suckling section 110.

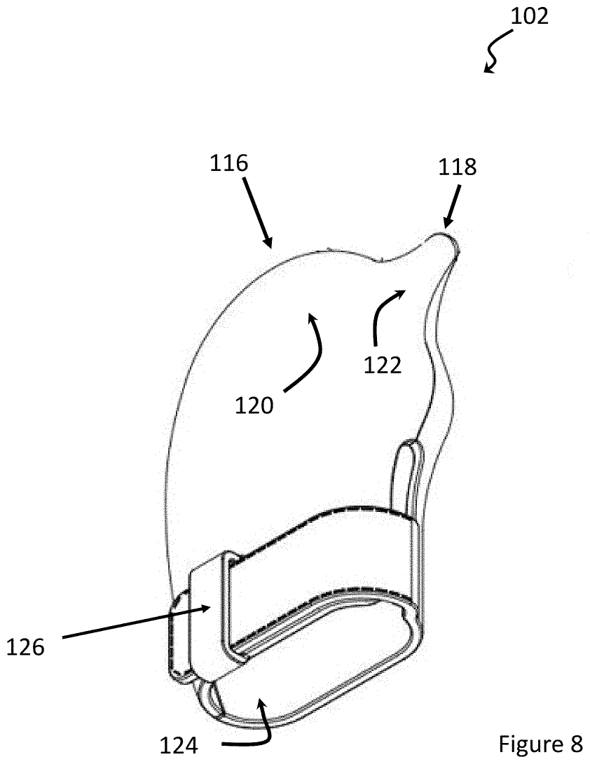

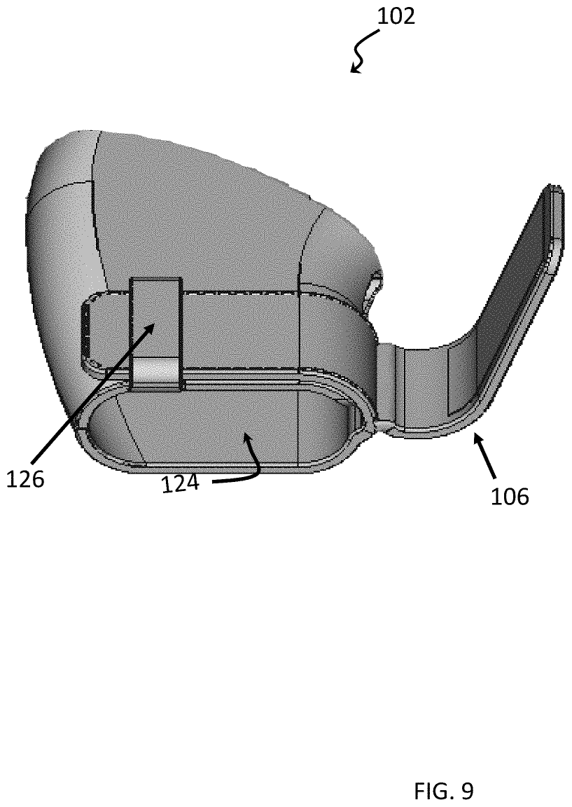

FIG. 8 depicts an exemplary embodiment of fabric mitten 102 for use with teething and suckling apparatus 100. Fabric mitten 102 may be formed of any suitable textile that may be configured into a mitten. Fabric mitten 102 may form an enclosure for receiving a human hand. With brief reference to FIG. 9, fabric mitten 102 is shown in a bottom perspective view. As shown in FIG. 9, and also in FIG. 8, fabric mitten 102 includes an opening 124 at a first end of fabric mitten 102 for inserting the hand.

Further still, fabric mitten 102 includes a first cavity 120 for receiving human fingers therein. That is, fabric mitten first cavity 120 maybe formed to enclose the human fingers except the human thumb. Even further, fabric mitten 102 may include a second cavity 122 that is formed for receiving the human thumb. In a preferred embodiment, second cavity 122 is substantially thumb-shaped. That is, second cavity 122 is ergonomically designed to accept the human thumb. That is, second cavity 122 may be dimensionally optimized to accept the average size infant thumb. By dimensionally optimized, what may be meant is that second cavity 122 configured to accept the average human thumb.

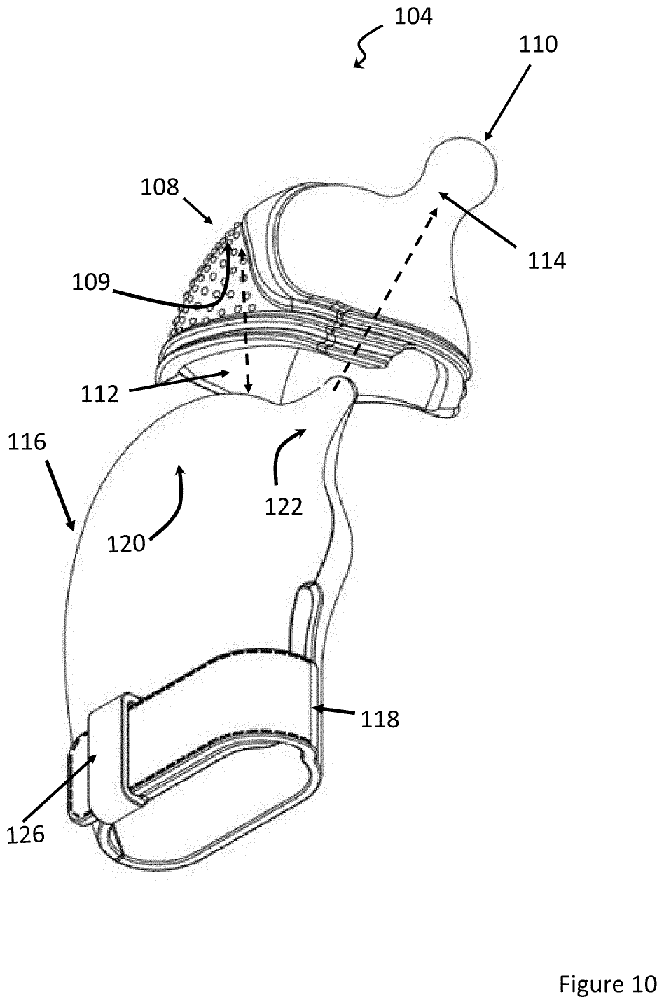

FIG. 10 is an exemplary depiction of fabric mitten 102, and teething and suckling device 104, in accordance with various embodiments of the invention, wherein fabric mitten 102 is mated with teething and suckling device 104. As shown, fabric mitten first cavity 120 includes an outer surface 116, which overlies first cavity 120. Similarly, fabric mitten second cavity 122 includes an outer surface 118, which overlies second cavity 120. In a preferred embodiment, outer surface 116 is distinct from outer surface 118.

During operation, wherein teething and suckling device 104 and fabric mitten 102 are used in combination, fabric mitten first cavity outer surface 116 may be placed into substantial abutment with a surface 109 of teething and suckling device 104 underlying teething section 108. Similarly, fabric mitten second cavity outer surface 118 may be placed in substantial abutment with a surface 113 of teething and suckling device 104 underlying suckling section 110. In this way, an infant's thumb, which has been placed into fabric mitten second cavity, is further placed into teething and suckling device second cavity 114. As noted, suckling section 110 may be nipple-shaped. Further, teething and suckling device second cavity 114 is ergonomically shaped to accept the infant's thumb. Moreover, since an infant is accustomed to sucking his thumb in lieu of the nipple, the infant will readily suckle the thumb inserted in the nipple-shaped portion of the invention.

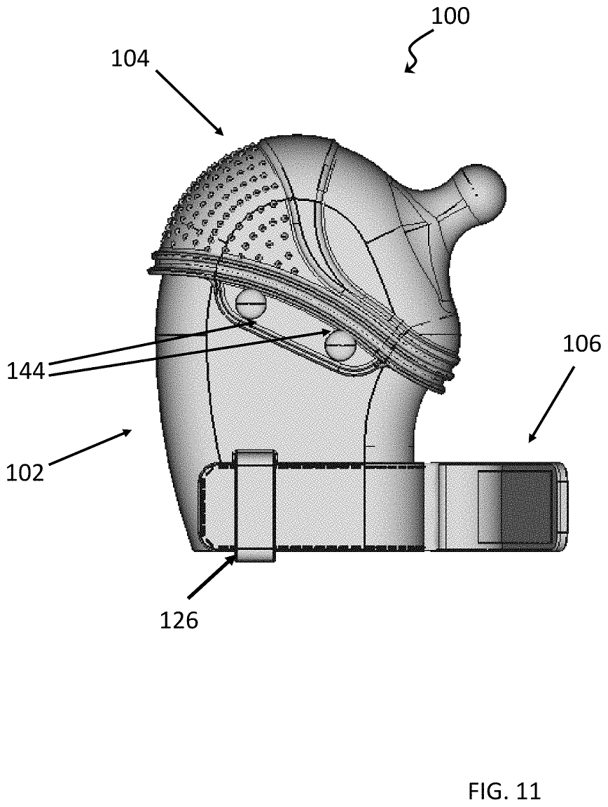

As previously noted, and depicted in FIG. 11, teething and suckling apparatus 104 further includes an elongated strap 106, positioned proximate to fabric mitten opening 124. During operation, elongated strap 106 may be cinched around an infant's wrist once the infant's hand is inserted into cavity 124, the infant's fingers are placed into fabric mitten first cavity 120, and the infant's thumb is inserted into fabric mitten second cavity 122.

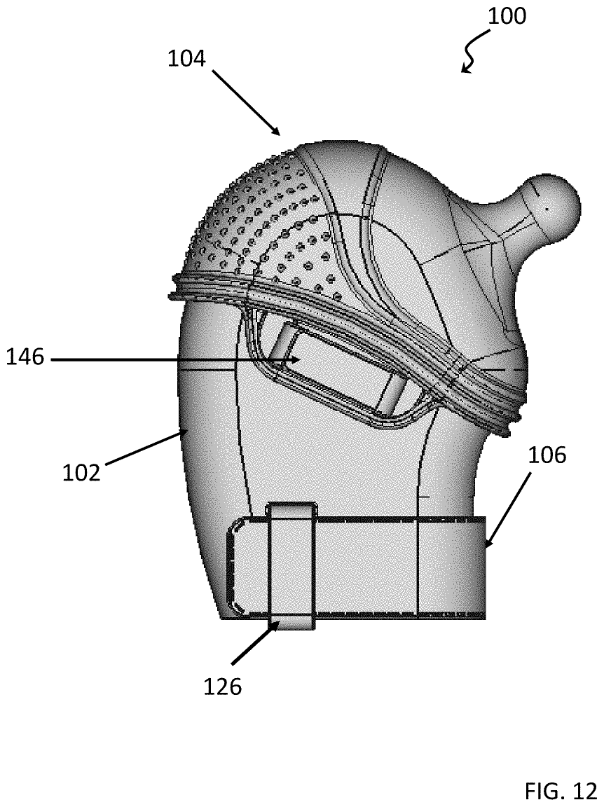

To ensure that the elongated strap 106 remains in place, elongated strap 106 may be affixed at a first location 136 on fabric mitten 102, and temporarily affixed to a second location 139 on fabric mitten 102. In a typical example, elongated strap first location 136 is distant from elongated strap second location 139. In one exemplary embodiment, depicted in FIGS. 12-14, elongated strap 106 may be affixed to one portion of fabric mitten 102. For example, an elongated strap second end 141 may be affixed in proximity to elongated strap first location 136.

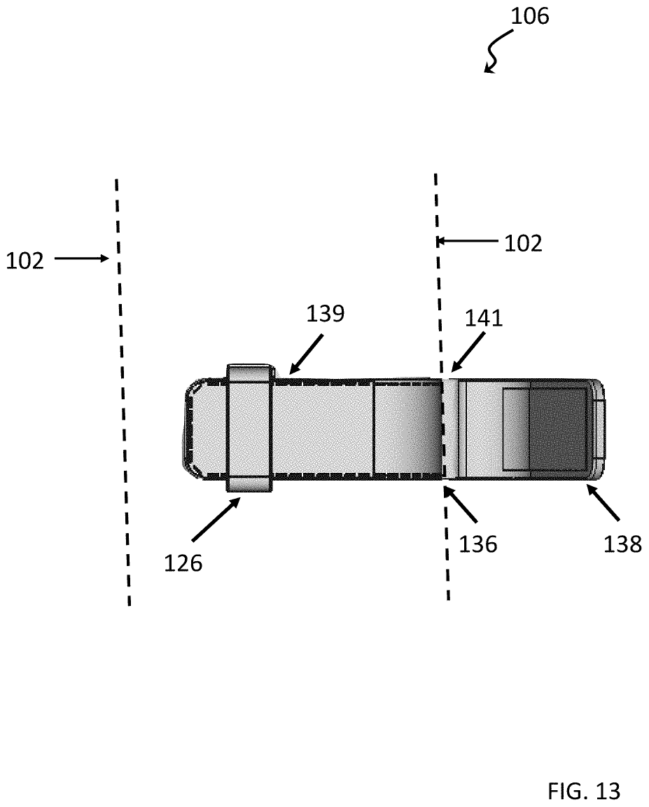

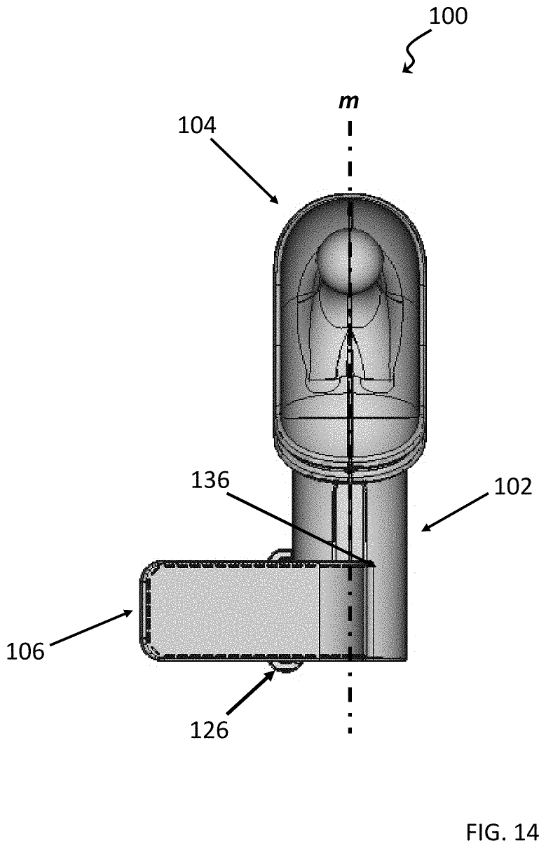

For example, with reference to FIG. 13, elongated strap 106 may be affixed proximate the midline, m, of teething and suckling apparatus 100. That is, elongated strap first location 136 may be proximate to the midline. As used herein, the midline may separate teething and sucking apparatus. As such, during operation, an elongated strap first end 134 may be manipulated to wrap around the infant's wrists. Once the elongated strap 106 is wrapped around the infant's wrist, elongated strap 106 may be affixed at a second location 138 on fabric mitten 102 using for example, a restraining strap 126, a button, snap hook and loop configuration, button, or the like. To further illustrate the movement of elongated strap 106, FIG. 13 and FIG. 14 show elongated strap first end 138 in an open position, wherein elongated strap second end 138 may be displaced from fabric mitten 102.

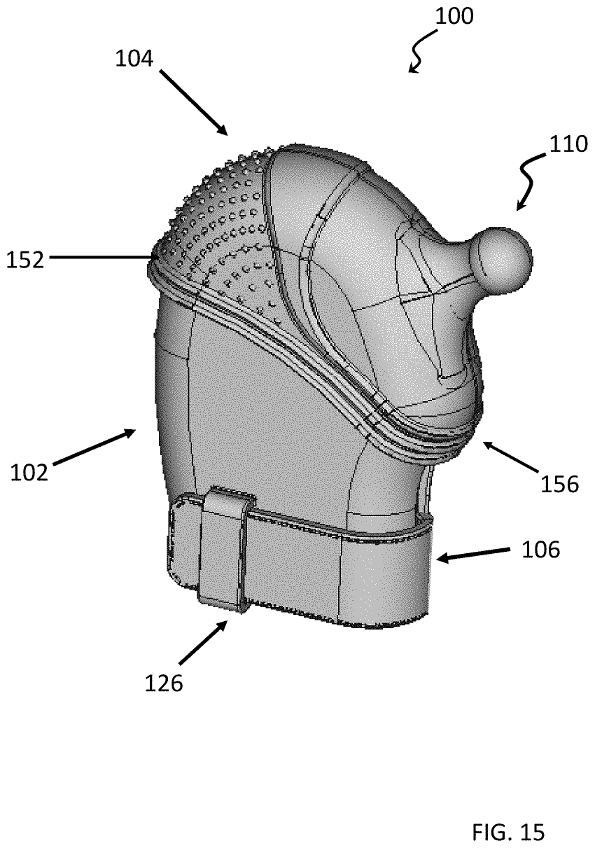

FIG. 15 depicts elongated strap 106 in a closed or fastened position, wherein elongated strap second end 138 may be moved to a second location wherein elongated strap end 138 is coupled to restraining strap 126. In the fastened position, elongated strap 106 may be cinched around an infant's wrist.

It should be noted, that teething and suckling device 104 may be affixed to fabric mitten 102 using various conventional means. For example, teething and suckling device 104 may be affixed to fabric mitten 102 using an adhesive. Alternative, teething and suckling device 104 may be sewed to fabric mitten 102. Further still, teething and suckling device 104 may be affixed to fabric mitten 102 using snaps 114, as shown in FIG. 10. In yet another embodiment, teething and suckling device 104 may be button to fabric mitten 102 using, for example, a button 146 shown in FIG. 12.

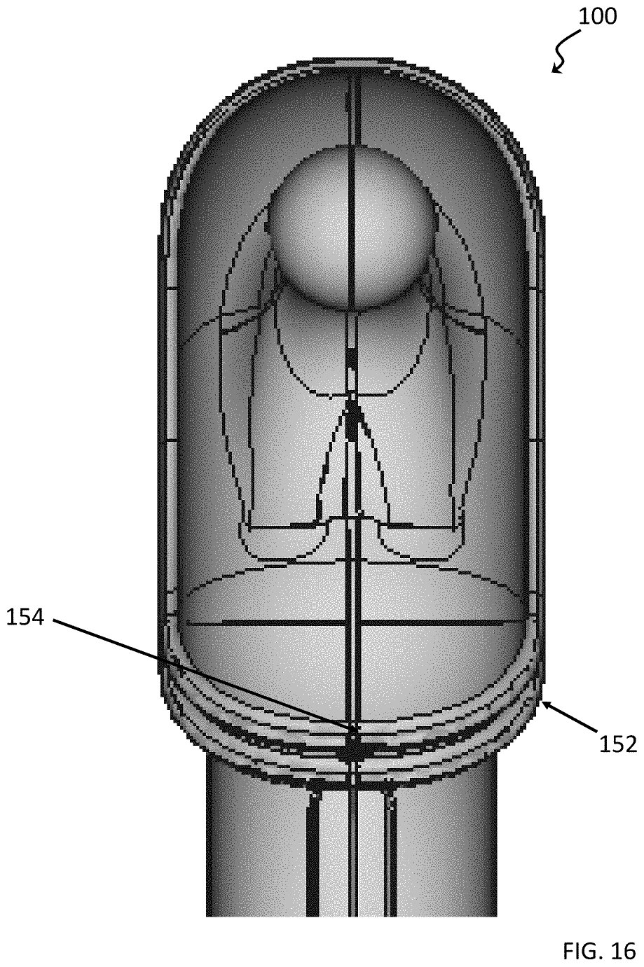

It is also well known that infants produce excess saliva when either teething or suckling. In such an instance, the excess saliva will build up on the outer surface of teething and suckling device 104. As shown in FIG. 16, teething and suckling device 104 may include a material projection 152 substantially around the outer perimeter of teething and suckling device 104. Material projection 152 may project outwardly from the perimeter edge of teething and suckling device 104. In one exemplary embodiment, material projection 152 is made integral to teething and suckling device 104.

During operation, material projection 152 may be used to prevent excess saliva from remaining on teething and suckling device 104 outer surface. As shown in FIG. 14, material projection 152 may slope from a higher position near teething device 108 to suckling device 110. Material projection 152 may slope from suckling device 108 to front 156. That is, an infant will hold teething apparatus 100 such that it will tilt toward the infant's mouth when the infant suckles. In this way, material projection 152 may direct excess saliva is directed toward the teething and suckling device front 156. Alternatively, material projection 152 may slope toward the teething device 108, when the infant is teething. When held in such a manner, material projection 152 may direct excess saliva to toward the teething section. Thus, saliva is directed again toward the front of teething and suckling apparatus 100. It should be note, as used herein, the front refers to the portion of the teething device held closest to the infant's mouth when in use.

As shown in FIGS. 15 and 16, material projection 152 may include a channel 154, through which excess saliva that directed toward teething and suckling device front 156 is channeled from the top surface of teething and sucking device 104. That is, while material projection 152 extends substantially around the teething and suckling device 104, material projection 152 may provide a channel 154, wherein there is a void of material projection. Consequently, because there is a void of material projection 102 at channel 154, excess saliva is directed from the teething and suckling device 104 to fabric mitten 102.

FIG. 16 is an exemplary embodiment of the teething and suckling apparatus 100 in front view, wherein material projection 152 is shown. As noted, projection 152 may include a material projection channel 154 for channeling excess saliva away from the outer surface of teething and suckling apparatus 100.

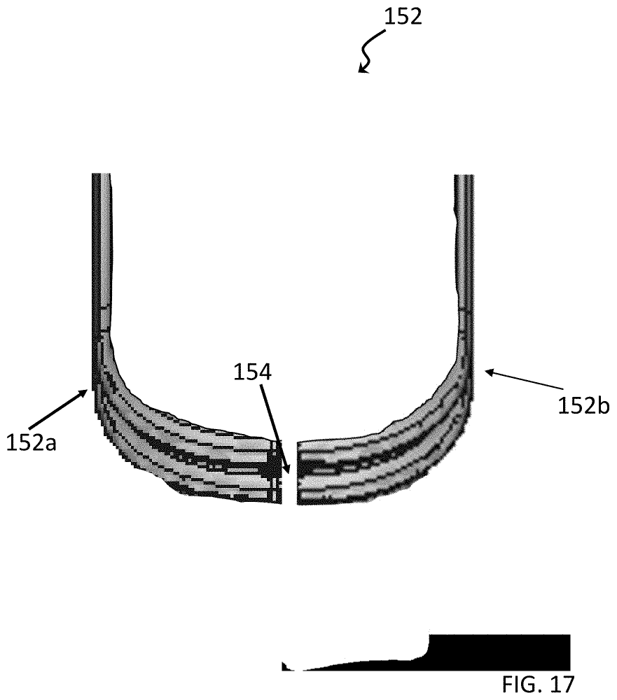

FIG. 17 is an exemplary material projection 152 that may be used in the present invention. As shown, material projection 152 may comprise multiple material projection sections 152a, 152b, wherein at least one channel 154 for directing the flow of saliva is located in between each section. In one particular embodiment, material projection 152 may only have 2 sections, wherein one channel is positioned on an opposite end of an adjacent section. In such a way, teething and suckling device 104 may include a channel on both the front and the back of material projection 152.

It should noted, that in some instances, it may be necessary to modify the present invention, but remain within the scope of what is being taught. For example, it may be necessary for the teething and suckling apparatus 100 to be formed of a single unit. Teething and suckling apparatus 100 may be comprised substantially of the same material composition. For example, teething and suckling apparatus 100 may be an article of manufacture. Mitten 102 may be constructed of a suitable textile for making a conventional mitten or a portion thereof.

It should be appreciated by one skilled in the art that the present invention teaches a teething and suckling apparatus that allows an infant to alternately teeth and suckle without the need to remove the device from the infant's hand. The invention further teaches a more ergonomic fabric mitten that takes into account the natural position of the infant's thumb. The invention further provides means for relieving excess saliva being deposited on the teething and suckling device.

Indeed, the foregoing description has been directed to specific embodiments of this invention. However, although the invention is described having the embodiments depicted, it will be appreciated that other variations and modifications may be made to the described embodiments, with the attainment of some or all of the advantages contained therein. Therefore, it is the object of the appended claims to cover all such variations and modifications as come within the true spirit and scope of the invention.

1. A teething and suckling apparatus, comprising:
a. a fabric enclosure having an enclosure opening for insertion of an infant's hand, a fabric enclosure first cavity configured to enclose multiple fingers of an infant's hand, the fabric enclosure first cavity having a fabric enclosure first cavity outer surface, a fabric enclosure second cavity configured to enclose an infant's thumb, the fabric enclosure second cavity having a fabric enclosure second cavity outer surface;
b. an article of manufacture affixed to the fabric enclosure, the article of manufacture defining an article of manufacture cavity for receiving the fabric enclosure, wherein the article of manufacture cavity includes an article of manufacture first cavity section for receiving the fabric enclosure first cavity outer surface, an article of manufacture second cavity section for receiving the fabric enclosure second cavity outer surface, wherein the article of manufacture first cavity section includes a textured teething outer surface, and wherein the article of manufacture second cavity section includes an article of manufacture second cavity outer surface configured with a nipple for nursing by an infant; and
c. a first perimeter projection around only a first portion of the perimeter of the article of manufacture cavity, a second perimeter projection around only a second portion of the perimeter of the article of manufacturer cavity, wherein the first portion of the perimeter of the article of manufacture cavity is distinct from the second portion of the perimeter of the article of manufacturer cavity, and wherein a first end of the first perimeter projection is adjacent to a first end of the second perimeter projection, and wherein the first end of the first perimeter projection separated from the second perimeter projection by a distance of d.

2. A teething and suckling apparatus of claim 1, further comprising an elongated strap affixed in proximity of the fabric enclosure opening, the elongated strap having an elongated strap first end, the elongated strap having an elongated strap second end, wherein the elongated strap first end is configured to removably attach to the elongated strap second end.

3. A teething and suckling apparatus of claim 1, wherein the article of manufacture is detachably affixed to the fabric enclosure.

4. A teething and sucking apparatus of claim 1, wherein the article of manufacture first cavity is separate and distinct from article of manufacture second cavity.

5. A teething and sucking apparatus of claim 1, wherein the first end of the first portion of the perimeter of the article of manufacture cavity is configured to slant toward the article of manufacture cavity, and wherein the first end of the second portion of the perimeter of the article of manufacture cavity is configured to slant toward the article of manufacture cavity.

6. A teething and suckling apparatus, comprising:
a. a fabric enclosure having an enclosure opening for insertion of an infant's hand, a fabric enclosure first cavity configured to enclose multiple fingers of an infant's hand, the fabric enclosure first cavity having a fabric enclosure first cavity outer surface, a fabric enclosure second cavity configured to enclose an infant's thumb, the fabric enclosure second cavity having a fabric enclosure second cavity outer surface;
b. an article of manufacture affixed to the fabric enclosure, the article of manufacture defining an article of manufacture cavity for receiving the fabric enclosure, wherein the article of manufacture cavity incudes an article of manufacture first cavity section for receiving the fabric enclosure first cavity outer surface, an article of manufacture second cavity section for receiving the fabric enclosure second cavity outer surface, wherein the article of manufacture first cavity section includes a textured teething outer surface, and wherein the article of manufacture second cavity section includes an article of manufacture second cavity outer surface configured with a nipple for nursing by an infant; and

7. A teething and suckling apparatus of claim 6, further comprising a first perimeter projection around only a first portion of the perimeter of the article of manufacture cavity, a second perimeter projection around only a second portion of the perimeter of the article of manufacturer cavity, wherein the first portion of the perimeter of the article of manufacture cavity is distinct from the second portion of the perimeter of the article of manufacturer cavity, and wherein a first end of the first perimeter projection is adjacent to a first end of the second perimeter projection, and wherein the first end of the first perimeter projection separated from the second perimeter projection by a distance of d.

8. A teething and suckling apparatus of claim 7, further comprising an elongated strap affixed in proximity of the fabric enclosure opening, the elongated strap having an elongated strap first end, the elongated strap having an elongated strap second end, wherein the elongated strap first end is configured to removably attach to the elongated strap second end.

9. A teething and suckling apparatus of claim 7, wherein the article of manufacture is detachably affixed to the fabric enclosure.

10. A teething and sucking apparatus of claim 7, wherein the article of manufacture first cavity is separate and distinct from article of manufacture second cavity.

11. A teething and sucking apparatus of claim 7, wherein the first end of the first portion of the perimeter of the article of manufacture cavity is configured to slant toward the article of manufacture cavity, and wherein the first end of the second portion of the perimeter of the article of manufacture cavity is configured to slant toward the article of manufacture cavity

12. A teething and suckling apparatus, comprising:
a. a fabric enclosure having an enclosure opening for insertion of an infant's hand, a fabric enclosure first cavity configured to enclose multiple fingers of an infant's hand, the fabric enclosure first cavity having a fabric enclosure first cavity outer surface, a fabric enclosure second cavity configured to enclose an infant's thumb, the fabric enclosure second cavity having a fabric enclosure second cavity outer surface;
b. an article of manufacture affixed to the fabric enclosure, the article of manufacture defining an article of manufacture cavity for receiving the fabric enclosure,
c. a first perimeter projection around only a first portion of the perimeter of the article of manufacture cavity, a second perimeter projection around only a second portion of the perimeter of the article of manufacturer cavity, wherein the first portion of the perimeter of the article of manufacture cavity is distinct from the second portion of the perimeter of the article of manufacturer cavity, and wherein a first end of the first perimeter projection is adjacent to a first end of the second perimeter projection, and wherein the first end of the first perimeter projection separated from the second perimeter projection by a distance of d.

13. A teething and suckling apparatus according to claim 12, wherein the article of manufacture cavity includes an article of manufacture first cavity section for receiving the fabric enclosure first cavity outer surface, an article of manufacture second cavity section for receiving the fabric enclosure second cavity outer surface, wherein the article of manufacture first cavity section includes a textured teething outer surface, and wherein the article of manufacture second cavity section includes an article of manufacture second cavity outer surface configured with a nipple for nursing by an infant.

14. A teething and suckling apparatus of claim 13, further comprising an elongated strap affixed in proximity of the fabric enclosure opening, the elongated strap having an elongated strap first end, the elongated strap having an elongated strap second end, wherein the elongated strap first end is configured to removably attach to the elongated strap second end.

15. A teething and suckling apparatus of claim 13, wherein the article of manufacture is detachably affixed to the fabric enclosure.

16. A teething and sucking apparatus of claim 13, wherein the article of manufacture first cavity is separate and distinct from article of manufacture second cavity.

17. A teething and sucking apparatus of claim 13, wherein the first end of the first portion of the perimeter of the article of manufacture cavity is configured to slant toward the article of manufacture cavity, and wherein the first end of the second portion of the perimeter of the article of manufacture cavity is configured to slant toward the article of manufacture cavity.
